(19) United States
(12) Patent Application Publication
(10) Pub. No.: US 2019/0115202 A1
(43) Pub. Date: Apr. 18, 2019

(54) MAGNET ASSEMBLY WITH IMPROVED FIELD UNIFORMITY AND METHODS OF MAKING AND USING SAME

(71) Applicant: Duke University, Durham, NC (US)

(72) Inventors: Jason J. AMSDEN, Durham, NC (US); Jeffrey T. GLASS, Durham, NC (US); Charles B. PARKER, Durham, NC (US); Michael E. GEHM, Durham, NC (US); Zach RUSSELL, Durham, NC (US); David LANDRY, Durham, NC (US); Shane DI DONA, Durham, NC (US)

(21) Appl. No.: 16/206,800

(22) Filed: Nov. 30, 2018

Related U.S. Application Data
(60) Provisional application No. 62/566,581, filed on Oct. 2, 2017.

(51) Int. Cl. H01J 49/32; H01F 7/02; H01F 41/00

(52) U.S. Cl. CPC H01J 49/328; H01F 41/00; H01F 7/0278

(57) ABSTRACT

An opposed dipole magnet assembly is provided that exhibits higher magnetic field uniformity than traditional magnet assemblies, such as H-shaped magnet assemblies. The opposed dipole magnet assembly includes two permanent magnets that are spaced apart and oriented such that their respective magnetization directions are parallel. Plates formed of a high permeability material are attached to top and bottom surfaces of the two permanent magnets so as to form a hollow field region. With this geometry, the magnetic field in the hollow field region is in a direction antiparallel to the magnetic field directions of the two permanent magnets.

### STATEMENT OF RELATED CASES

This application claims priority to U.S. Provisional Application Ser. No. 62/566,581, filed Oct. 2, 2017, whose entire disclosure is incorporated herein by reference.

### GOVERNMENT RIGHTS

This invention was made with government support under Federal Grant No. DE-AR0000546 awarded by the Department of Energy. The government has certain rights in this invention.

### FIELD OF THE INVENTION

The present invention relates to magnet assemblies in general and, more particularly, to a magnet assembly with a geometry that improves magnetic field uniformity.

### BACKGROUND OF THE INVENTION

Cycloidal mass analyzers are unique sector mass analyzers as they exhibit perfect double focusing, making them ideal for incorporating spatial aperture coding, which can increase the throughput of a mass analyzer without affecting the resolving power. Cycloidal mass analyzers utilize orthogonal electric and magnetic fields and the ion travel paths are coplanar with the electric field. As governed by the Lorentz force, the perpendicular magnetic field induces circular motion on the ions. The electric field affects the kinetic energy of the ions. Combined, the magnetic and electric fields induce cycloidal trajectories.

The unique focusing properties of the cycloidal mass analyzer depends on having highly uniform fields. For a completely uniform electric field, the focal plane is aligned with the plane of the ion source exit slit. A uniform gradient in the electric field shifts the focal plane above or below the plane of the ion source exit slit, while a uniform gradient in the magnetic field rotates the focal plane. For an ion imaging system, these field perturbations blur the image captured by the detector. With aperture coding, a blurred image can make reconstruction more difficult and lower the resolving power.

Thus, there is a need for magnet assemblies that exhibit improved magnetic field uniformity for use in cycloidal mass analyzers and other applications that require high magnetic field uniformity.

### SUMMARY OF THE INVENTION

An object of the invention is to solve at least the above problems and/or disadvantages and to provide at least the advantages described hereinafter.

The present invention provides an opposed dipole magnet assembly that exhibits higher magnetic field uniformity than traditional magnetic assemblies used in cycloidal mass analyzers, such as H-shaped magnet assemblies. The opposed dipole magnet assembly includes two permanent magnets that are spaced apart and oriented such that their respective magnetization directions are parallel. Plates formed of a material exhibiting magnetic permeability are attached to top and bottom surfaces of the two permanent magnets so as to form a hollow field region. With this geometry, the magnetic field in the hollow field region is in a direction antiparallel to the magnetic field directions of the two permanent magnets.

An embodiment of the invention is a magnet assembly, comprising: a first permanent magnet having a top surface and a bottom surface and a first magnetization direction; a second permanent magnet having a top surface and a bottom surface and a second magnetization direction, wherein the second permanent magnet is spaced apart from the first permanent magnet, and wherein the first and second permanent magnets are positioned and oriented such that the first and second magnetization directions are parallel; a first material that exhibits magnetic permeability affixed to the top surfaces of the first and second permanent magnets; and a second material that exhibits magnetic permeability affixed to the bottom surfaces of the first and second permanent magnets; wherein the first and second permanent magnets and the first and second high materials that exhibit magnetic permeability together define a hollow field region, wherein a magnetic field direction in the hollow field region is antiparallel to the first and second magnetization directions.

Another embodiment of the invention is a method of making a magnet assembly, comprising: providing two permanent magnets with respective top and bottom surfaces; positioning and orienting the two permanent magnets such that they are spaced apart and such that their respective magnetization directions are parallel; affixing a first material that exhibits magnetic permeability to the top surfaces of the two permanent magnets; and affixing a second material that exhibits magnetic permeability to the bottom surfaces of the two permanent magnets; wherein the two permanent magnets and the first and second high materials that exhibit magnetic permeability together define a hollow field region, wherein a magnetic field direction in the hollow field region is antiparallel to the magnetization directions of the two permanent magnets.

### BRIEF DESCRIPTION OF THE DRAWINGS

The invention will be described in detail with reference to the following drawings, in which like reference numerals refer to like elements, wherein:

FIG. 1A is a perspective view of a traditional H-shaped magnet assembly;

FIGS. 1B-1E are plots showing the results of COMSOL simulations for the H-shaped magnet assembly of FIG. 1A;

FIG. 2A is a perspective view of an opposed dipole magnet assembly, in accordance with an illustrative embodiment of the present invention;

FIGS. 2B-2E are plots showing the results of COMSOL simulations for the opposed dipole magnet assembly of FIG. 2A, in accordance with an illustrative embodiment of the present invention;

FIG. 3 is a flowchart of a method of making an opposed dipole magnet assembly, in accordance with an illustrative embodiment of the present invention; and

FIG. 4 is a cutaway view of a cycloidal mass analyzer that utilizes the opposed dipole magnet assembly of the present invention, in accordance with an illustrative embodiment of the present invention.

### DETAILED DESCRIPTION OF PREFERRED EMBODIMENTS

In the following detailed description of various embodiments of the present invention, numerous specific details are set forth in order to provide a thorough understanding of various aspects of one or more embodiments. However, the one or more embodiments may be practiced without some or all of these specific details. In other instances, well-known methods, procedures, and/or components have not been described in detail so as not to unnecessarily obscure aspects of embodiments.

Articles “a” and “an” are used herein to refer to one or to more than one (i.e. at least one) of the grammatical object of the article. By way of example, “an element” means at least one element and can include more than one element. Unless otherwise defined, all technical terms used herein have the same meaning as commonly understood by one of ordinary skill in the art to which this disclosure belongs.

While preferred embodiments are disclosed, still other embodiments of the system and method of the present invention will become apparent to those skilled in the art from the following detailed description, which shows and describes illustrative embodiments. As will be realized, the following disclosure is capable of modifications in various obvious aspects, all without departing from the spirit and scope of the present invention. Also, the reference or non-reference to a particular embodiment of the invention shall not be interpreted to limit the scope of the present invention.

The present invention is particularly suited for implementing a cycloidal mass analyzer, and will be described in this context. However, it should be appreciated that the present invention can be used in connection with any application in which high magnetic field uniformity is desired.

As discussed above, the unique focusing properties of the cycloidal mass analyzer depends on having highly uniform fields. One type of magnet assembly that has been traditionally used for cycloidal mass analyzers is an “H-shaped” magnet assembly, so called because the magnetic flux lines through a cross-section resemble the letter “H.” The present invention provides an opposed dipole magnet assembly that exhibits higher magnetic field uniformity than traditional magnetic assemblies, such as H-shaped magnet assemblies.

Both the traditional H-shaped magnet assembly and the opposed dipole magnet assembly of the present invention will be discussed and compared in more detail below. The performance of both the H-shaped magnet assembly and the opposed dipole magnet assembly of the present invention are evaluated via simulations that were performed with the COMSOL® Multiphysics simulation software (version 5.2) using the AC/DC and Charged Particle Tracing modules (hereinafter collectively referred to as “COMSOL”). The AC/DC module calculates the magnetostatic and electrostatic fields, while the Charged Particle Tracing module simulates ions travelling through the mass analyzer.

To reduce computation time while maintaining high fidelity in the regions of interest, the ion travel plane is meshed more finely than the remainder of the geometric model. The ion travel plane is meshed with a minimum element size of 5 μm and a maximum element size of 0.5 mm. The volume around this plane contains mesh elements between 1 mm and 80 mm in size. The magnet assemblies are meshed with elements between 14.4 mm and 80 mm in size. A box extends more than 300 mm beyond the magnet assembly in every direction with mesh elements ranging in size from 56 mm to 400 mm. It is important to note that this bounding box must be sufficiently large to prevent the edges of the simulation from affecting the field simulation. The size of the bounding box was determined by increasing its size until further increases no longer affected the simulated field.

### Magnetic Field Simulations

Two types of materials were used for the magnet geometric models: annealed grade 416 stainless steel (SS) and the rare earth permanent magnet Nd—Fe—B. Material properties for the 416 SS were obtained from the nonlinear magnetic materials library in COMSOL. The library defines a B—H curve for the material, which allows for more accurate calculations than using a single permeability value. This also allows COMSOL to simulate magnetic saturation of the material. The Nd—Fe—B magnet, grade N50, is defined with a remnant flux density Bᵣ of 1.4 T and minimum coercivity of 923 kA/m.

### Electric Field Simulations

The electric field model assumes copper electrodes, with material properties obtained from the COMSOL materials library. Using the electrostatic physics interface in COMSOL, electrode voltages were assigned to the model to generate a constant value electric field along the region of interest.

### Charged Particle Tracing Simulations

Simulated ion trajectories were used to evaluate the quality of the new magnetic and electric sectors. To isolate the effect of the magnetic field, the magnet array results assume a completely uniform electric field of 706 V/m. Electric sector results use simulated magnetic and electric fields.

To simulate ion trajectories, singly and doubly charged argon with mass to charge ratios of m/z=40 and m/z=20, respectively, were emitted from an ion source with an aperture at the geometric center of the magnet. The aperture is spatially coded with a modified S11 pattern, a binary Hadamard code. The pattern consists of three slits. It has overall dimensions of 550×350 with a total open area of 300×350 Its smallest feature is 50×350 μm. The ions had energies of 14±2 eV and an angular distribution of 0.0±9.5° in the x-y plane measured from the y-axis. The angular distribution in the y-z plane is 0°. Ions with mass to charge ratios of 20 and 40 were chosen, as they reach opposite ends of the detector array used in the cycloidal mass analyzer.

### H-Shaped Magnet Assembly

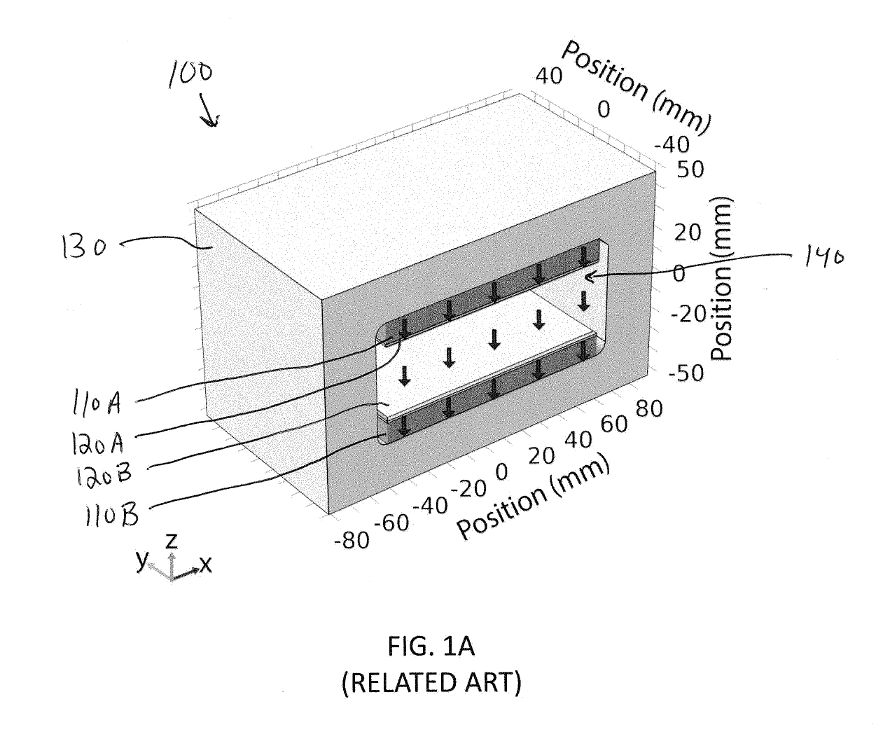

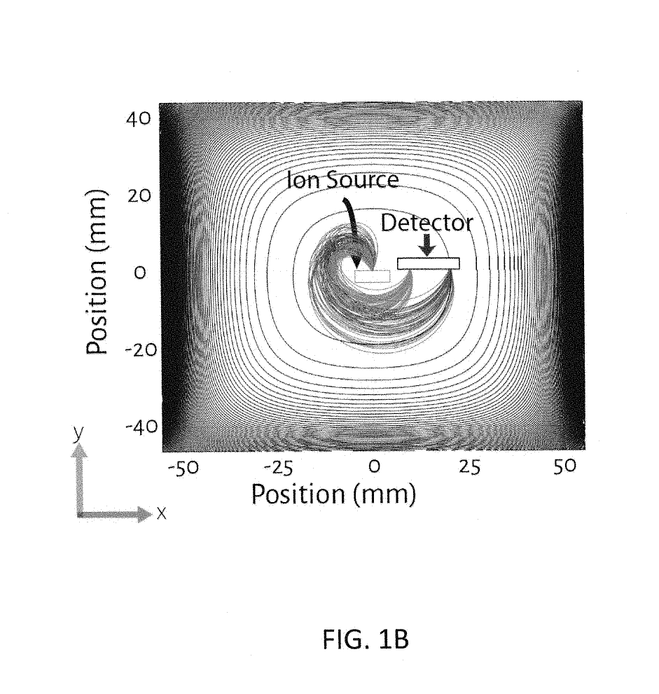

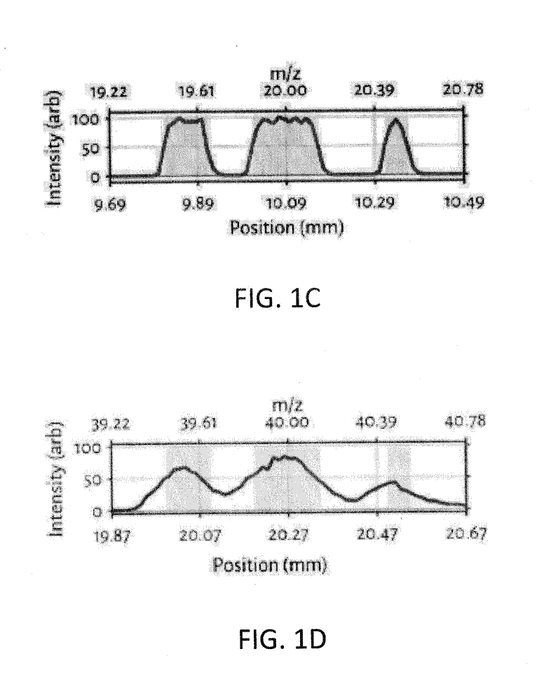

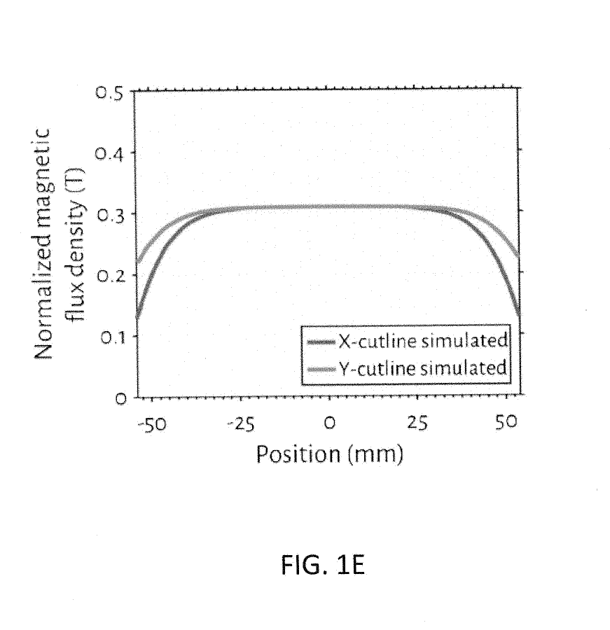

FIG. 1A is a schematic diagram of a traditional H-shaped magnet assembly 100. The assembly 100 is comprised of two Nd—Fe—B permanent magnets 110A and 110B, two inner-facing pole pieces of 416 SS 120A and 120B attached to magnets 110A and 110B, respectively, and a 416 SS yoke 130 that wraps around the structure, thereby connecting the two magnets 120A and 120B. The Nd—Fe—B magnets 120A and 120B are magnetized in the −z-direction, producing a −z-direction field in the gap between them. The arrows denote the direction of the magnetic flux lines.

In the H-shaped magnet assembly example shown in FIG. 1A, the outer dimensions of the yoke and assembly are 170×90×100 mm. The hollow field region 140 is 110×90 mm in the x-y plane. The magnets 110A and 110B are 10 mm thick. The pole pieces 120A and 120B are 2 mm thick with chamfered edges. The gap between pole pieces 120A and 120B is 35 mm Based on the volume and density of materials, the assembly weighs approximately 9 kg.

FIGS. 1B-1E show the results of COMSOL simulations for the H-shaped magnet assembly 100. FIG. 1B is a plot of ion trajectories starting at the aperture at the top of the ion source to the detector, along a plane cut through the center of the ion travel region (hollow field region 140) for z=0. The ion trajectories are shown as red and blue lines for the 20 m/z ions and 40 m/z ions, respectively. Contour lines show field strength in increments of 1% of peak strength. The strongest part of the field is in the center.

Differing initial energies and angles cause each ion to follow a different path through the field. FIG. 1B illustrates the degree of field non-uniformity and the resulting ion trajectories for both 20 m/z and 40 m/z. All 20 m/z ions remained inside the 1% contour line. However, several 40 m/z ion trajectories extend beyond the 1% contour line.

To investigate the aperture imaging quality, the place where each ion crossed the detector plane was examined and a detector reading was simulated by plotting a histogram and binning ion locations to match the detector in the experimental apparatus. The detector has 1704 detection elements along the length of the x-axis. Each element is 12×3 mm. The histogram was normalized to a peak value of 100.

FIG. 1C is a plot of the simulated detector reading centered on where the 20 m/z ions strike the detector. The grey boxes in the plot represent the aperture pattern. The signal returns to baseline between the slits in the aperture pattern. A simulation with a 50 slit produced an image with a FWHM of approximately 50 μm, indicating good imaging quality.

FIG. 1D is a plot of the simulated detector reading centered where 40 m/z ions strike the detector. While the signal follows the general aperture pattern, the signal is blurred to the point that it does not return to baseline between the slits in the aperture pattern. A simulation with just a single 50 μm slit simulation produced an image with a FWHM of 113 μm.

FIG. 1E is a plot of the field strengths along the x- and y-axes, centered in the middle of the ion travel region (hollow field region 140) for the z=0 plane. The assembly 100 has a peak field of 0.3 T. The field strength varies less than 1% across a region of 43×46 mm and drops rapidly outside this region. Across the entire extent, field strength varies by 29% and 52% for x- and y-axes, respectively.

In summary, aperture imaging quality was good for m/z of 20. However, aperture imaging quality for m/z of 40 was relatively poor. The main difference between the 20 m/z and 40 m/z ion trajectories is that the 40 m/z trajectories cover a larger area, over which the magnetic field varies by greater than 1%. Therefore, one can conclude that, assuming a uniform electric field, a magnetic field variation of less than 1% is required for good aperture imaging.

### Opposed Dipole Magnet Assembly

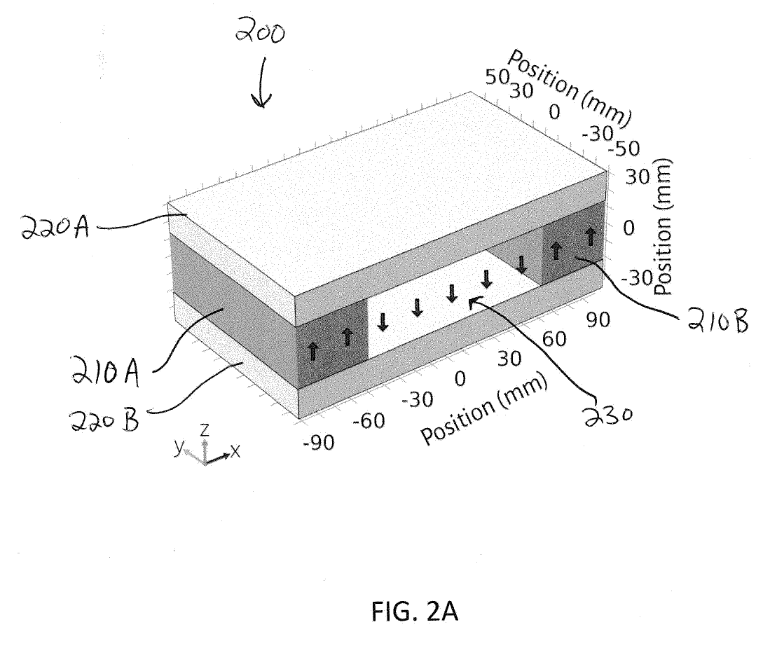

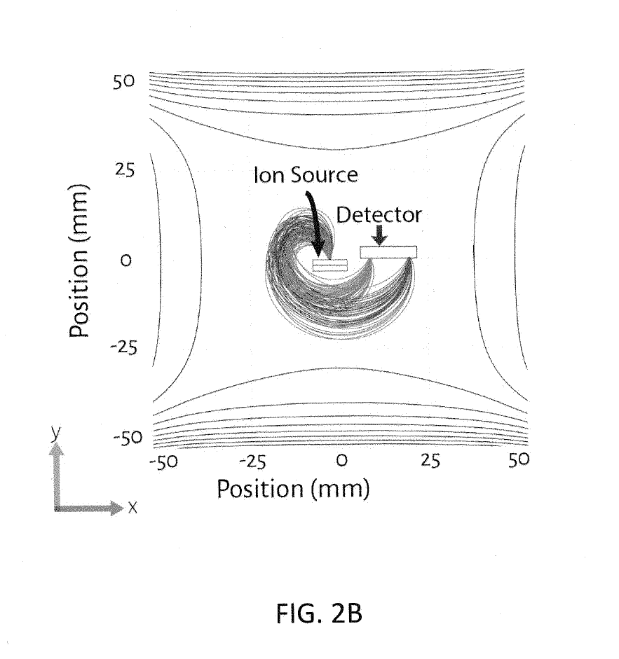

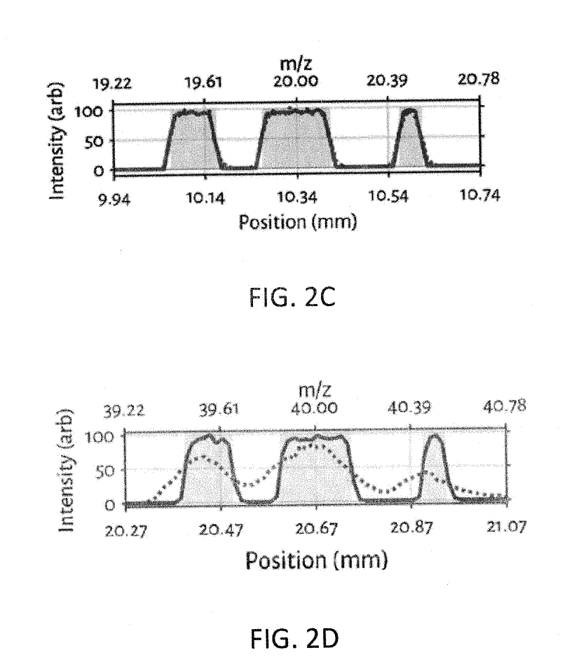

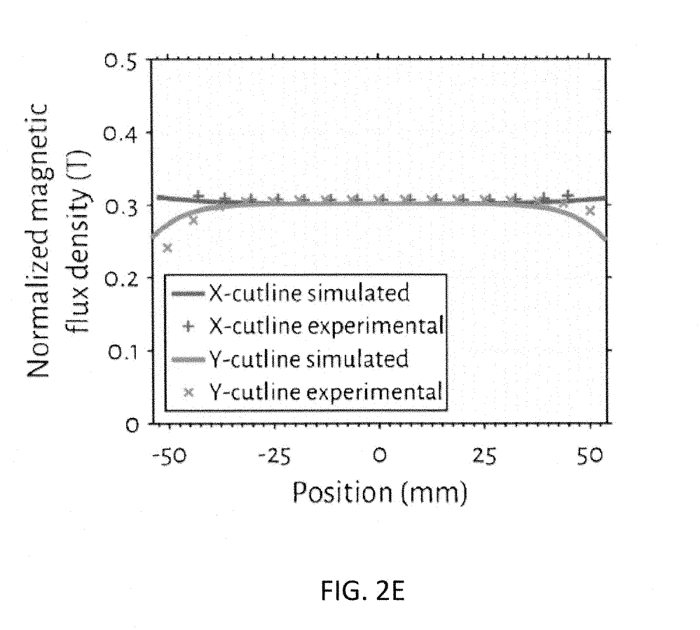

FIG. 2A is a schematic diagram of an opposed dipole magnet assembly 200, in accordance with an illustrative embodiment of the present invention. The magnet assembly 200 is composed of two permanent magnets 210A and 210B and two plates 220A and 220B formed of a high permeability material to conduct the magnetic flux. The magnets 210A/210B are preferably stable against any influences that would demagnetize them, and they generally can be of any strength. However, if the opposed dipole magnet assembly 200 will be used in connection with a cycloidal mass analyzer, then magnets 210A/210B preferably exhibit a high magnetic field (a remnant flux density Bᵣ preferably greater than 0.1 T) and have a low mass (preferably less than 5 kg). The permanent magnets 210A/210B are suitably Nd—Fe—B magnets, such as NdFeB or Nd₂Fe₁₄B. However, other types of magnets can be used including, but not limited to, SmCo, BaFe₁₂O₁₉, Alnico IV, Alnico V, Alcomax I, MnB1, Ce(CuCo)₅, SmCo5 and Sm₂Co₁₇.

Arrows denote the direction of the magnetic flux lines. The magnets 210A/210B are spaced apart and oriented such that their respective magnetization directions are parallel (in the +z-direction in the illustrative embodiment of FIG. 1A).

The two plates 220A/220B may be formed of any material exhibiting magnetic permeability, such as a ferromagnetic metal (e.g., any metal that comprises iron, nickel and/or cobalt). The material exhibiting magnetic permeability is preferably a high permeability material. The phrase “high permeability material” refers to a material having a relative permeability preferably greater than 10. In one embodiment, the plates 220A/220B are formed of stainless steel (SS), such as 416 SS.

Plate 220A is affixed to the top surfaces of magnets 210A and 210B, and plate 220B is affixed to bottom surfaces of magnets 210A and 210B so as to form a hollow field region 230. The plates 220A/220B may be affixed using any means known in the art such as, for example, adhesives, mechanical fastening, welding and the like. The top and bottom surfaces of the magnets 210A/210B to which plates 220A/220B are affixed are preferably perpendicular to the magnetization direction of the magnets 210A/210B. Further, the plates 220A/220B do not have to physically contact the surfaces of magnets 210A/210B. For example, there may be an adhesive layer (not shown) between the magnets 210A/210B and the plates 220A/220B in order to affix the plates 220A/220B to the magnets 210A/210B. As another example, one may optionally include a layer of material for corrosion protection (not shown), such as nickel plating, between the plates 220A/220B and magnets 210A/210B.

In the embodiment illustrated in FIG. 2A, the magnets 210A/210B and the plates 220A/220B are rectangular shaped. However, the shapes of the magnets 210A/210B and the plates 220A/220B can be varied while still falling within the scope of the present invention. For example, the magnets 210A/210B could be formed from several pieces and have rhomboid or trapezoidal shapes. The plates 220A/220B, for example, could be circular shaped and the thickness of plates 220A/220B can vary.

The plates 220A/220B, together with the magnets 210A/210B, produce a −z-direction field in the field region 230 (for magnet 210A/210B magnetization directions of +z), which is the ion travel region. In contrast to the H-shaped magnet discussed above, the magnets 210A/210B are magnetized antiparallel to the direction of the field in the hollow field region 230.

In the illustrative embodiment shown in FIG. 2A, the outer dimensions of the assembly are 194×110×69 mm, the hollow field region (gap 230) is 110×110×35 mm, and the magnets 210A/210B are each 42×110×35 mm. If Nd—Fe—B magnets are used for magnets 210A/210B, and 416 SS plates are used for plates 220A/220B, then the entire assembly 200 weighs approximately 8 kg based on the volume and density of the materials. The specific dimensions given here are merely one illustrative example. It should be appreciated that different dimensions can be used for the magnets 210A/210B and plates 220A/220B while still falling within the scope of the present invention. In other words, the overall size of the opposed dipole magnet assembly 200, the size of the magnets 210A/210B, the size of the plates 220A/220B and the size of the hollow field region 140 (which is determined, in part, by the size of the magnets and plates) can be varied depending on the application.

The hollow field region 230 of the magnet assembly 200 is preferably accessible from at least one side of the magnet assembly 200 so as to allow for the insertion and removal of items, such as components for a cycloidal mass analyzer. In the embodiment illustrated in FIG. 2A, the magnet assembly 200 is accessible from two opposing sides of the magnet assembly 200 (only one open side is shown in FIG. 2A).

FIGS. 2B-2E show the results of COMSOL simulations for the opposed dipole magnet assembly 200. FIG. 2B is a plot of ion trajectories starting at the aperture at the top of the ion source to the detector, along a plane cut through the center of the ion travel region (hollow field region 230) for z=0. The ion trajectories are shown as red and blue lines for the 20 m/z ions and 40 m/z ions, respectively. Contour lines show field strength in increments of 1% of peak strength. The strongest part of the field is in the center.

FIG. 2B illustrates the degree of field non-uniformity and the resulting ion trajectories for both 20 m/z and 40 m/z. The ions are modeled with the same initial angle and energy described above in connection with the H-shaped magnet assembly 100. As shown in FIG. 2B, the ion trajectories for both the 20 m/z and 40 m/z ions are in a region in which the field varies by less than 1%.

To investigate the aperture imaging quality, detector readings were simulated utilizing the same method described above in connection with the H-shaped magnet assembly 100.

FIGS. 2C and 2D plot the detector signal centered at 20 m/z and 40 m/z, respectively. The grey boxes in the plots represent the aperture pattern. The dotted lines in FIGS. 2C and 2D are the overlaid results for the H-shaped magnet assembly 100 (the dotted line is difficult to see in FIG. 2C because the results for the H-shaped magnet assembly 100 tracks closely with the results for the opposed dipole magnet assembly 200.

For both 20 m/z and 40 m/z, the signal returns to baseline between each slit following the aperture pattern. A simulation with a 50 μm slit produced 50 μm images at both 20 m/z and 40 m/z locations, indicating good imaging for both 20 m/z and 40 m/z ions and confirming that aperture imaging requires a magnetic field variation of less than 1%.

FIG. 2E is a plot of the field strengths along the x- and y-axes, centered in the middle of the ion travel region (hollow field region 230) for z=0. Peak field is slightly larger than 0.3 T, located at the left and right extremes of the x-axis. The field strength varies less than 1% across a region 62 mm×65 mm, which is approximately 33% of the area defined by a plane at z=0. Across the entire extent, field strength varies by 3% and 18% for x- and y-axes, respectively.

To verify the simulations, an opposed dipole magnet assembly 200 was fabricated and the magnetic field for the fabricated assembly was mapped in the plot of FIG. 2E using a Lakeshore 460 Gaussmeter with 3-axis Hall probe mounted on a precision XYZ station, which is incorporated into a LabVIEW real time data acquisition system. The experimental results are plotted as ‘x’s in FIG. 2E. The experimental and simulated fields match closely along the x-axis. Along the y-axis, there is a slight asymmetry in the fabricated assembly due to slightly different properties in each of the permanent magnets 210A and 210B compared to the symmetrical simulated version.

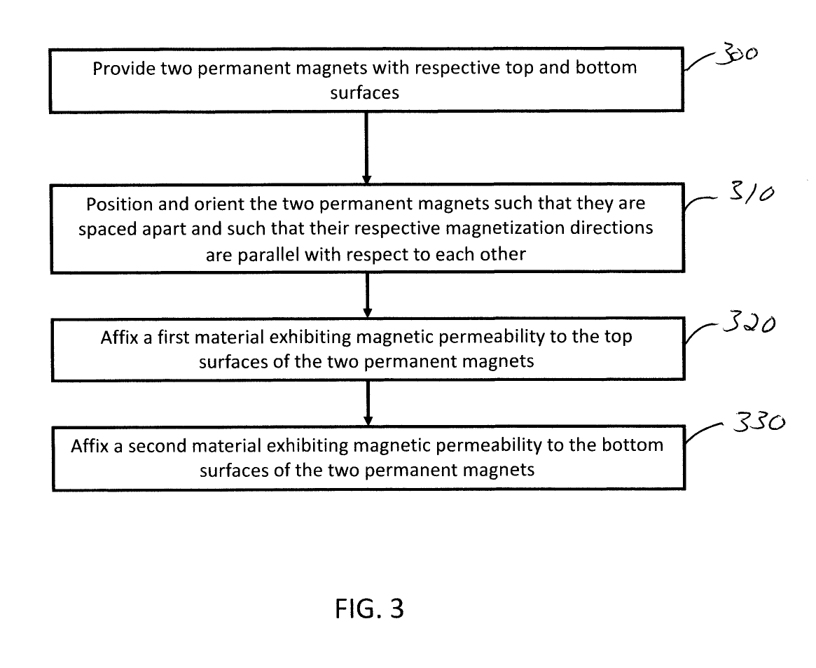

FIG. 3 is a flowchart of a method of making an opposed dipole magnet assembly, in accordance with an illustrative embodiment of the present invention. The method starts at step 300, where two permanent magnets are provided with respective top and bottom surfaces. In one preferred embodiment, the top and bottom surfaces of each permanent magnet are perpendicular to the respective magnet's magnetization direction. At step 310, the two permanent magnets are positioned and oriented such that they are spaced apart and such that their respective magnetizations directions are parallel with respect to each other.

At step 320, a material exhibiting magnetic permeability, preferably a high permeability material, is affixed to the top surfaces of the two permanent magnets. Then, at step 330, a second material exhibiting magnetic permeability, preferably a high permeability material, is affixed to the bottom surfaces of the two permanent magnets. In one preferred embodiment, the first and second materials exhibiting magnetic permeability are plates, and the plates may be affixed to the surfaces of the magnets using any means known in the art such as, for example, adhesives, mechanical fastening, welding and the like.

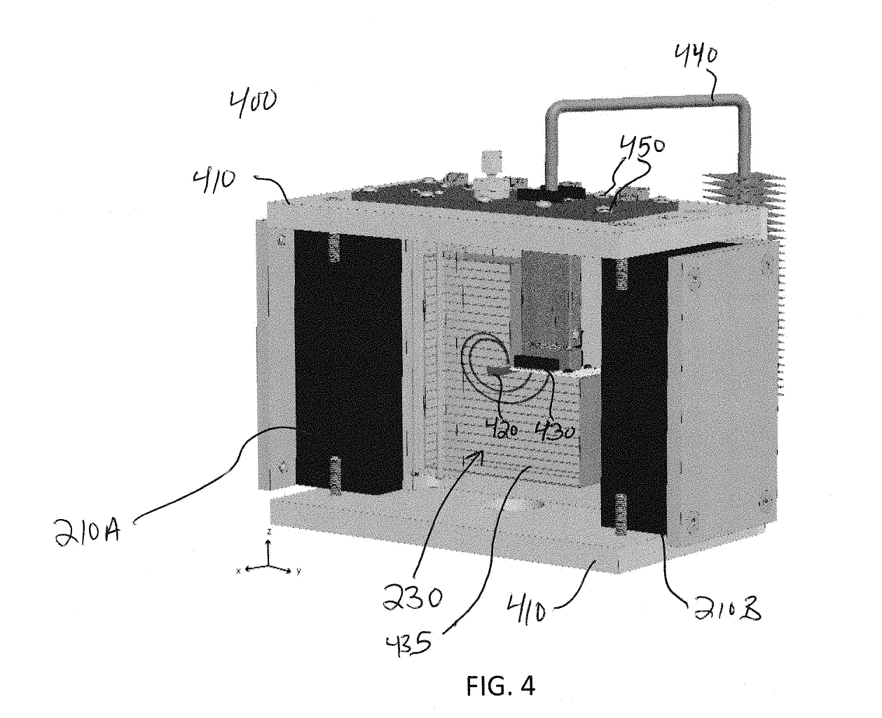

As discussed above, the present invention is particularly suited for implementing a cycloidal mass analyzer. FIG. 4 is a cutaway schematic diagram of a cycloidal mass analyzer that utilizes the opposed dipole magnet assembly 200 of the present invention. In FIG. 4, the permanent magnets 210A and 210B are shown, but the plates 220A and 220B are not shown in order to not obscure the components in the hollow field region 230.

The cycloidal mass analyzer 400 includes a vacuum manifold 410 (only a portion of the vacuum manifold 410 is shown so as to not obscure the hollow field region 230), an ion source 420, a detector 430, an electric sector 435 and other cycloidal mass analyzer components that are positioned in the hollow field region 230. The cycloidal mass analyzer 400 also includes components outside the hollow field region 230, such as a heat pipe 440 and vacuum feedthroughs 450.

The foregoing embodiments and advantages are merely exemplary, and are not to be construed as limiting the present invention. The description of the present invention is intended to be illustrative, and not to limit the scope of the claims. Many alternatives, modifications, and variations will be apparent to those skilled in the art. Various changes may be made without departing from the spirit and scope of the invention.

What is claimed is:

1. A magnet assembly, comprising:
a first permanent magnet having a top surface and a bottom surface and a first magnetization direction;
a second permanent magnet having a top surface and a bottom surface and a second magnetization direction, wherein the second permanent magnet is spaced apart from the first permanent magnet, and wherein the first and second permanent magnets are positioned and oriented such that the first and second magnetization directions are parallel;
a first material that exhibits magnetic permeability affixed to the top surfaces of the first and second permanent magnets; and
a second material that exhibits magnetic permeability affixed to the bottom surfaces of the first and second permanent magnets;
wherein the first and second permanent magnets and the first and second materials that exhibit magnetic permeability together define a hollow field region, wherein a magnetic field direction in the hollow field region is antiparallel to the first and second magnetization directions.

2. The magnet assembly of claim 1, wherein the top and bottom surfaces of the first permanent magnet are perpendicular to the first magnetization direction, and the top and bottom surfaces of the second permanent magnet are perpendicular to the second magnetization direction.

3. The magnet assembly of claim 1, wherein the first and second permanent magnets are rectangular shaped.

4. The magnet assembly of claim 3, wherein the first material that exhibits magnetic permeability comprises a first metal plate and the second material that exhibits magnetic permeability comprises a second plate.

5. The magnet assembly of claim 4, wherein the first and second plates are formed of stainless steel.

6. The magnet assembly of claim 1, wherein the first and second materials that exhibit magnetic permeability comprise a high permeability material.

7. The magnet assembly of claim 1, wherein the first and second permanent magnets are selected from the group consisting of NdFeB, Nd₂Fe₁₄B, SmCo, BaFe₁₂O₁₉, Alnico IV, Alnico V, Alcomax I, MnB1, Ce(CuCo)₅, SmCo5, Sm₂Co₁₇ and combinations thereof.

8. The magnet assembly of claim 1, wherein the first and second materials that exhibits magnetic permeability are affixed to the top and bottom surfaces, respectively, of the first and second permanent magnets with an adhesive.

9. The magnet assembly of claim 1, wherein the hollow field region is accessible from at least one side of the magnet assembly, such that items can be inserted into and removed from the hollow field region.

10. The magnet assembly of claim 9, wherein the items comprise components for a cycloidal mass analyzer.

11. The magnet assembly of claim 1, wherein a magnetic field strength in the hollow field region along an axis perpendicular to the magnetization direction of the first and second permanent magnets varies by no more than approximately 3%.

12. The magnet assembly of claim 1, wherein a magnetic field strength in the hollow field region along an axis parallel to the magnetization direction of the first and second permanent magnets varies by no more than approximately 18%.

13. A mass analyzer comprising the magnet assembly of claim 1.

14. A method of making a magnet assembly, comprising:
providing two permanent magnets with respective top and bottom surfaces;
positioning and orienting the two permanent magnets such that they are spaced apart and such that their respective magnetization directions are parallel;
affixing a first high material that exhibits magnetic permeability to the top surfaces of the two permanent magnets; and
affixing a second material that exhibits magnetic permeability to the bottom surfaces of the two permanent magnets;
wherein the two permanent magnets and the first and second materials that exhibit magnetic permeability together define a hollow field region, wherein a magnetic field direction in the hollow field region is antiparallel to the magnetization directions of the two permanent magnets.

15. The method of claim 14, wherein the two permanent magnets are rectangular shaped.

16. The method of claim 15, wherein the first and second materials that exhibit magnetic permeability each comprise a metal plate.

17. The method of claim 16, wherein the metal plates are formed of stainless steel.

18. The method of claim 17, wherein the first and second materials that exhibit magnetic permeability comprise a high permeability material.

19. The method of claim 14, wherein the two permanent magnets are selected from the group consisting of NdFeB, Nd₂Fe₁₄B, SmCo, BaFe₁₂O₁₉, Alnico IV, Alnico V, Alcomax I, MnB1, Ce(CuCo)₅, SmCo5, Sm₂Co₁₇ and combinations thereof.

20. The method of claim 14, wherein the hollow field region is accessible from at least one side of the magnet assembly, such that items can be inserted into and removed from the hollow field region.
